(19) United States
(12) Patent Application Publication
(10) Pub. No.: US 2023/0024376 A1
(43) Pub. Date: Jan. 26, 2023

(54) SPRING PIN TERMINALS FOR AN ELECTRICAL CONNECTOR ASSEMBLY THAT PROVIDES MECHANICAL AND ELECTRICAL CONNECTIONS BETWEEN TWO ELECTRICALLY CONDUCTIVE STRUCTURES

(71) Applicant: Lear Corporation, Southfield, MI (US)

(72) Inventor: Hyoun Lee, Rochester, MI (US)

(73) Assignee: Lear Corporation, Southfield, MI (US)

(21) Appl. No.: 17/380,460

(22) Filed: Jul. 20, 2021

(51) Int. Cl. H01R 13/24; H01R 13/428

(52) U.S. Cl. CPC H01R 13/2435; H01R 13/428; H01R 12/72

(57) ABSTRACT

An electrical connector assembly includes a housing defining an interior space and a slot and a spring pin terminal disposed within the slot of the housing. The spring pin terminal includes a first contact portion, a second contact portion, and an intermediate portion that extends between the first contact portion and the second contact portion. The first contact portion includes a contact point that engages a first electrically conductive structure and a retention force support that engages a portion of the intermediate portion of the spring pin terminal. The second contact portion includes a contact point that engages a second electrically conductive structure and a retention force and alignment support that engages the intermediate portion of the spring pin terminal.

### BACKGROUND OF THE INVENTION

This invention relates in general to electrical connector assemblies that provide mechanical and electrical connections between two electrically conductive structures, such as between a flat flexible conductor and a printed circuit board. In particular, this invention relates to an improved structure for a spring pin terminal that can be used in such an electrical connector assembly.

Many electrical systems are known in the art that include one or more electrically operated devices. For example, most automobiles and other vehicles include a variety of electrically operated devices that can be selectively operated for the comfort and convenience of a driver or an occupant. Typically, each of these electrically operated devices is connected to a source of electrical energy (and/or other components of the electrical system) by one or more electrical conductors. In many instances, electrical connector assemblies are provided on or with the electrical conductors for facilitating the installation, service, and removal of these electrically operated devices to and from the electrical system.

One conventional structure for an electrical connector assembly includes an outer housing (which is usually formed from an electrically non-conductive material) and a plurality of spring pin terminals (each of which is usually formed from an electrically conductive material) supported within the housing. The outer housing typically has first and second openings extending therethrough, and the spring pin terminals are supported within the housing adjacent to those first and second openings. The first opening facilitates the passage of a first electrically conductive structure (such as a flat flexible wire, cable, or other conductor having a plurality of electrically conductive traces) through the housing into engagement with the spring pin terminals supported therein. The second opening facilitates the passage of a second electrically conductive structure (such as a printed circuit board having a plurality of electrically conductive traces) through the housing into engagement with the spring pin terminals supported therein. Thus, the spring pin terminals supported within the electrical connector assembly provide electrically conductive connections between the traces of the first electrically conductive structure and the associated traces of the second electrically conductive structure.

In the past, the connections of the spring pin terminals to either or both of the first and second electrically conductive structures have been accomplished using a variety of specialized tools and/or specialized methods, such as soldering or crimping. Although effective, it has been found that the use of these known specialized tools and/or methods are relatively time-consuming and complicated to use. Thus, it would be desirable to provide an improved structure for a spring pin terminal that can be used in an electrical connector assembly that provides mechanical and electrical connections between two electrically conductive structures, such as between a flat flexible conductor and a printed circuit board.

### SUMMARY OF THE INVENTION

This invention relates to an improved structure for a spring pin terminal that can be used in an electrical connector assembly that provides mechanical and electrical connections between two electrically conductive structures, such as between a flat flexible conductor and a printed circuit board. The spring pin terminal includes a first contact portion, a second contact portion, and an intermediate portion that extends between the first contact portion and the second contact portion. The first contact portion includes a contact point that is adapted to engage a portion of a first electrically conductive structure and a retention force support that is adapted to engage a portion of the intermediate portion of the spring pin terminal. The second contact portion includes a contact point that is adapted to engage a portion of a second electrically conductive structure and a retention force and alignment support that is adapted to engage a portion of the intermediate portion of the spring pin terminal.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is an exploded perspective view of an exemplary electrical connector assembly that provides mechanical and electrical connections between two electrically conductive structures, the electrical connector assembly including a housing, a plurality of spring pin terminals in accordance with this invention, and a connector position assurance.

FIG. 2 is an enlarged side sectional view of the housing of the electrical connector assembly of FIG. 1 including a locking arm that is shown in an opened position.

FIG. 3A is a perspective view of a first embodiment of one of the plurality of spring pin terminals of FIG. 1.

FIG. 3B is a perspective view of second embodiment of one of the plurality of spring pin terminals of FIG. 1.

FIG. 3C is a perspective view of a third embodiment of one of the plurality of spring pin terminals of FIG. 1.

FIG. 4 is a side sectional view showing the housing of the electrical connector assembly of FIG. 2 after assembly with the first embodiment of the spring pin terminal of FIG. 3A.

FIG. 5 is an exploded side sectional view showing the housing of the electrical connector assembly of FIG. 4 after assembly with the connector position assurance of FIG. 1 (shown in an unlocked position) and before assembly with the flat flexible conductor of FIG. 1.

FIG. 6 is a side sectional view showing the housing of the electrical connector assembly of FIG. 5 after assembly with the flat flexible conductor and before the locking arm has been moved from the opened position to a closed position.

FIG. 7 is a side sectional view showing the housing of the electrical connector assembly of FIG. 6 after the locking arm has been moved from the opened position to the closed position.

FIG. 8 is an exploded side sectional view showing the housing of the electrical connector assembly of FIG. 7 before assembly with the printed circuit board of FIG. 1.

FIG. 9 is a side sectional view showing the housing of the electrical connector assembly of FIG. 8 after assembly with the printed circuit board.

FIG. 10 is a side sectional view showing the connector position assurance of FIG. 9 after being moved from the unlocked position to a locked position.

### DETAILED DESCRIPTION OF THE PREFERRED EMBODIMENTS

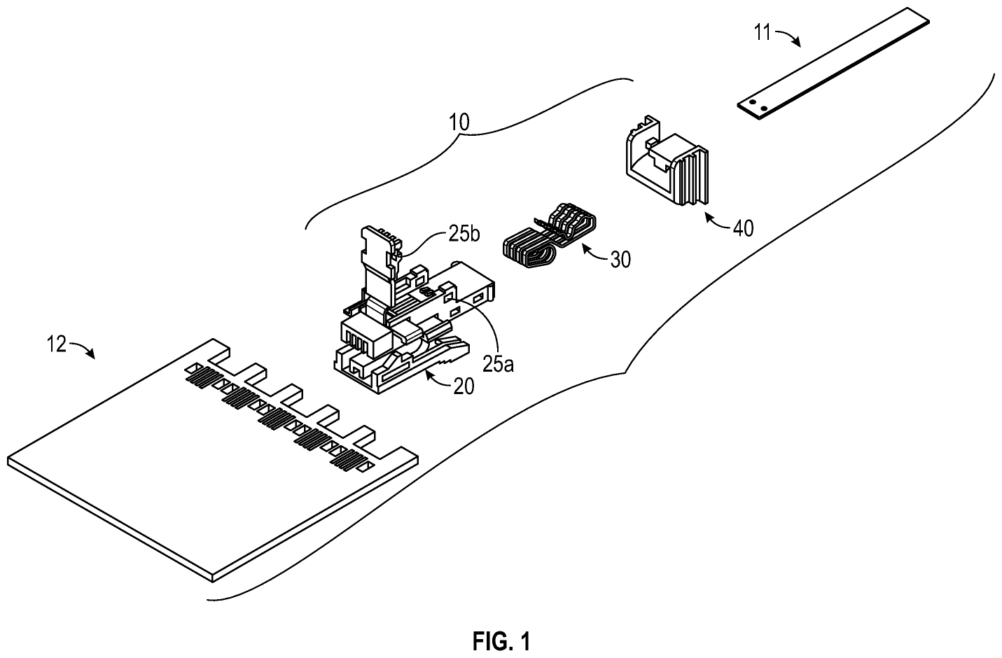

Referring now to the drawings, there is illustrated in FIG. 1 an electrical connector assembly, indicated generally at 10, in accordance with this invention for providing a direct mechanical and electrical connection between a first electrically conductive structure 11 and a second electrically conductive structure 12. As will be explained in greater detail below, the structure of the electrical connector assembly 10 is, in large measure, conventional in the art. Thus, the scope of this invention is not intended to be limited to the specific structure for the electrical connector assembly 10 described and illustrated herein, or to electrical connector assemblies in general. On the contrary, as will become apparent below, this invention may be used in any desired environment for the purposes described below.

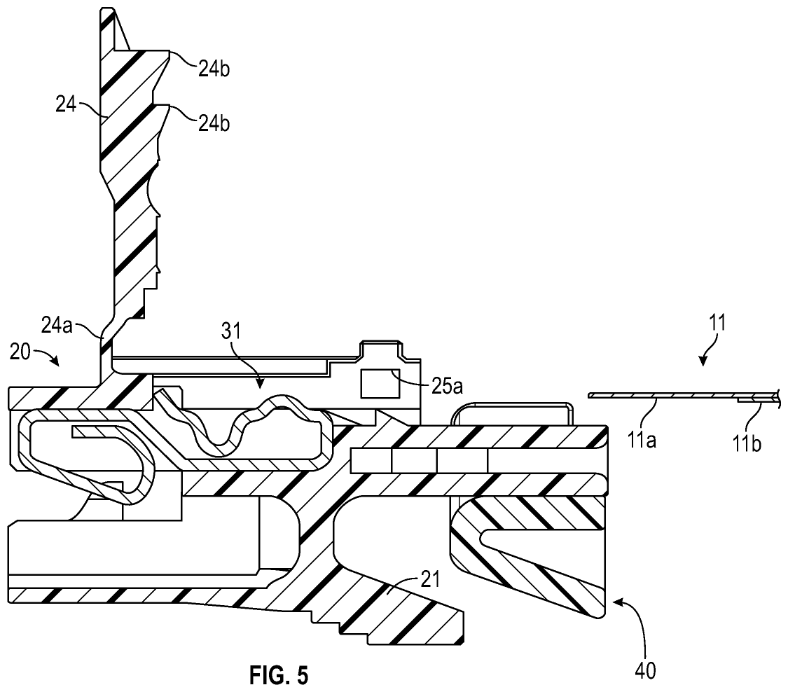

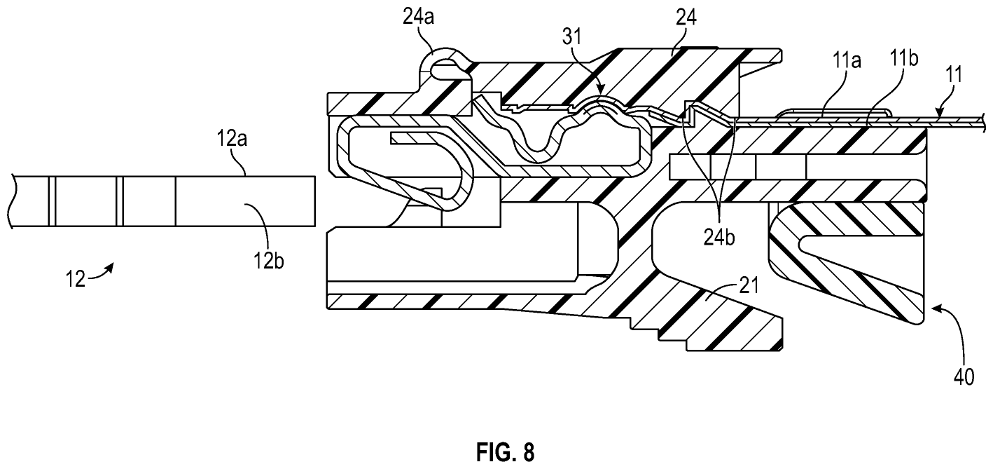

The illustrated first electrically conductive structure 11 is a flat flexible wire, cable, or other conductor including one or more electrically conductive traces 11a (best shown in FIG. 5) that are surrounded by an outer electrically non-conductive insulator 11b. However, the first electrically conductive structure 11 may have any other desired structure. The illustrated second electrically conductive structure 12 is a printed circuit board 12 including one or more electrically conductive traces 12a (best shown in FIG. 8) that are provided on an electrically non-conductive substrate 12b. However, the second electrically conductive structure 12 may have also any other desired structure.

As discussed above, most automobiles and other vehicles include a variety of electrically operated devices that can be selectively operated for the comfort and convenience of a driver or an occupant. Typically, each of these electrically operated devices is connected to a source of electrical energy (and/or other components of the electrical system) by one or more electrical conductors. The electrically conductive traces 11a of the first electrically conductive structure 11 and the electrically conductive traces 12a of the printed circuit board 12 can be used for this purpose.

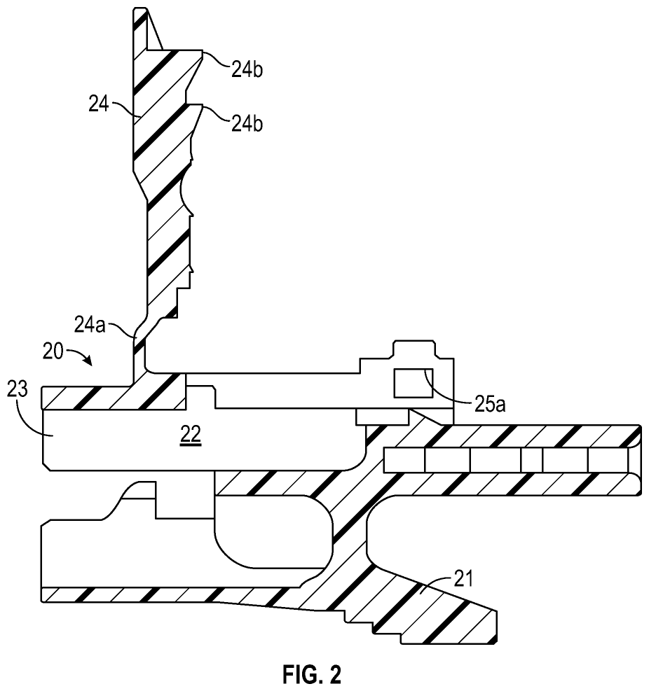

The structure of the electrical connector assembly 10 will now be described in detail with reference to FIGS. 2 through 10. As shown therein, the electrical connector assembly 10 includes a housing, indicated generally at 20, that is preferably formed from an electrically non-conductive material, such as plastic. However, the housing 20 may be formed from any desired material. The illustrated housing 20 includes a body 21 that defines an interior space 22. Within the interior space 22 of the body 21, a plurality of dividers 23 is provided. In the illustrated embodiment, three such dividers 23 are formed integrally with the body 21. Together with opposed sides of the body 21, the three dividers 23 separate a portion of the interior space 22 of the body 21 into four adjacent and parallel slots. However, any desired number of such dividers 23 may be provided to separate the portion of the interior space 22 of the body 21 into any desired number of such slots. The purposes for the dividers 23 and the slots defined thereby will be explained below.

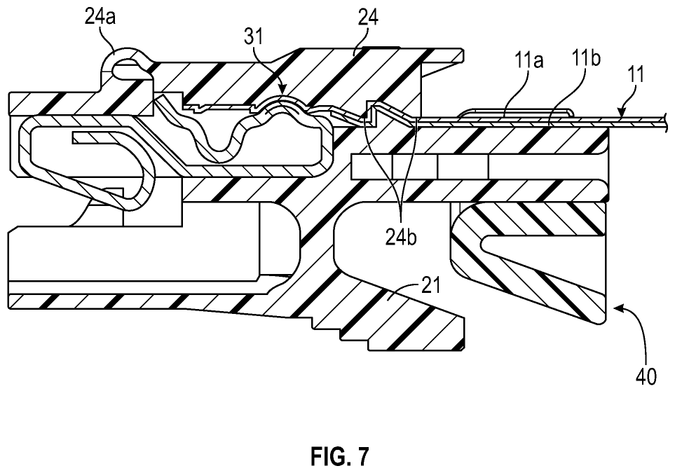

A locking arm 24 is also provided on the body 21 of the housing 20. In the illustrated embodiment, the locking arm 24 is formed integrally with a living hinge 24a that, in turn, is formed integrally with the body 21 of the housing 20. Thus, the illustrated locking arm 24 is supported on the body 21 of the housing 20 for pivoting movement relative thereto between an unlocked position (illustrated in FIGS. 1, 2, 4, 5, and 6) and a locked position (illustrated in FIGS. 7 through 10). However, the locking arm 24 may be supported on the body 21 of the housing 20 or otherwise provided in any desired manner. The illustrated locking arm 24 has a pair of barbs 24b provided on a surface thereof. Additionally, mating retainer portions 25a and 25b (see FIG. 1) are respectively provided on the body 21 and the locking arm 24. The purposes for the locking arm 24, the barbs 24b, and the retainer portions 25a and 25b will also be explained in detail below.

The electrical connector assembly 10 also includes one or more spring pin terminals, indicated generally at 30 in FIG. 1. Preferably, the number of such spring pin terminals 30 is the same as the number of slots provided in the interior space 22 of the body 21 of the housing 20. Thus, in the illustrated embodiment, the electrical connector assembly 10 includes four of such spring pin terminals 30. However, a greater or lesser number of such spring pin terminals 30 may be provided. As will be explained in detail below, each of the spring pin terminals 30 includes a first contact portion that is adapted to engage a portion of the first electrically conductive structure (i.e., one of the traces 11a of the flat flexible conductor 11), a second contact portion that is adapted to engage a portion of the second electrically conductive structure (i.e., one of the traces 12a of the printed circuit board 12), and an intermediate contact portion that extends between the first contact portion and the second contact portion.

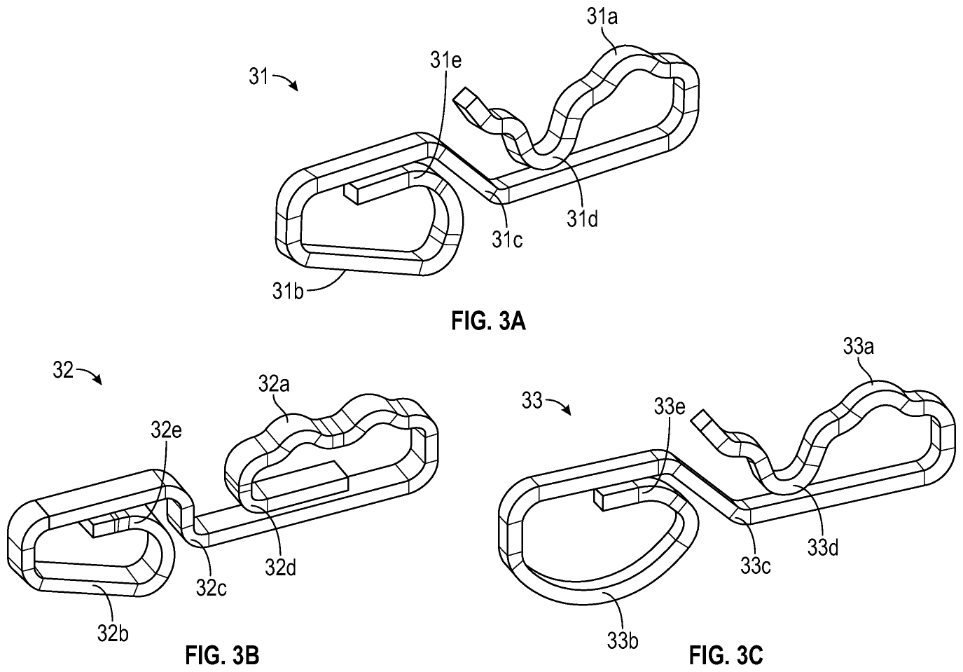

FIG. 3A illustrates a first embodiment, indicated generally at 31, of one of the spring pin terminals 30 of FIG. 1. As shown therein, the first embodiment of the spring pin terminal 31 includes a first contact portion 31a, a second contact portion 31b, and an intermediate portion 31c that extends between the first contact portion 31a and the second contact portion 31b. In this first embodiment of the spring pin terminal 31, the first contact portion 31a includes a single curved contact point (which is adapted to engage one of the traces 11a of the flat flexible conductor 11 when inserted within the body 21 of the housing 20 as described below) and a curved retention force support 31d (which is adapted to engage a portion of the intermediate portion 31c of the spring pin terminal 31 as also described below). The second contact portion 31b includes a linear contact point (which is adapted to engage one of the traces 12a of the printed circuit board 12 when inserted within the body 21 of the housing 20 as described below) and a curved retention force and alignment support 31e (which is adapted to engage a portion of the intermediate portion 31c of the spring pin terminal 31 as also described below). Thus, as will be explained in detail below, the first contact portion 31a and the second contact portion 31b are resiliently urged into engagement with the associated traces 11a and 12a of the flat flexible conductor 11 and the printed circuit board 12.

FIG. 3B illustrates a second embodiment, indicated generally at 32, of one of the spring pin terminals 30 of FIG. 1. As shown therein, the second embodiment of the spring pin terminal 32 includes a first contact portion 32a, a second contact portion 32b, and an intermediate portion 32c that extends between the first contact portion 32a and the second contact portion 32b. In this second embodiment of the spring pin terminal 32, the first contact portion 32a includes two curved contact points (which are both adapted to engage one of the traces 11a of the flat flexible conductor 11 when inserted within the body 21 of the housing 20 as described below) and an angled retention force support 32d (which is adapted to engage the intermediate portion 32c of the spring pin terminal 32 as also described below). The second contact portion 32b includes a linear contact point (which is adapted to engage one of the traces 12a of the printed circuit board 12 when inserted within the body 21 of the housing 20 as described below) and a curved retention force and alignment support 32e (which is adapted to engage the intermediate portion 32c of the spring pin terminal 32). Thus, as will be explained in detail below, the second contact portion 32a and the second contact portion 32b are resiliently urged into engagement with the associated traces 11a and 12a of the flat flexible conductor 11 and the printed circuit board 12.

FIG. 3C illustrates a third embodiment, indicated generally at 33, of one of the spring pin terminals 30 of FIG. 1. As shown therein, the third embodiment of the spring pin terminal 33 includes a first contact portion 33a, a second contact portion 33b, and an intermediate portion 33c that extends between the first contact portion 33a and the second contact portion 33b. In this third embodiment of the spring pin terminal 33, the first contact portion 33a includes a single curved contact point (which is adapted to engage one of the traces 11a of the flat flexible conductor 11 when inserted within the body 21 of the housing 20 as described below) and a curved retention force support 33d (which is adapted to engage the intermediate portion 33c of the spring pin terminal 33 as also described below). The second contact portion 33b includes a curved contact point (which is adapted to engage one of the traces 12a of the printed circuit board 12 when inserted within the body 21 of the housing 20 as described below) and an angled retention force and alignment support 33e (which is adapted to engage the intermediate portion 33c of the spring pin terminal 33 as also described below). Thus, as will be explained in detail below, the contact portion 33a and the second contact portion 33b are resiliently urged into engagement with the associated traces 11a and 12a of the flat flexible conductor 11 and the printed circuit board 12.

The electrical connector assembly 10 further includes a connector position assurance, indicated generally at 40. The structure and manner of operation of the connector position assurance is generally conventional in the art and will be described in further detail below.

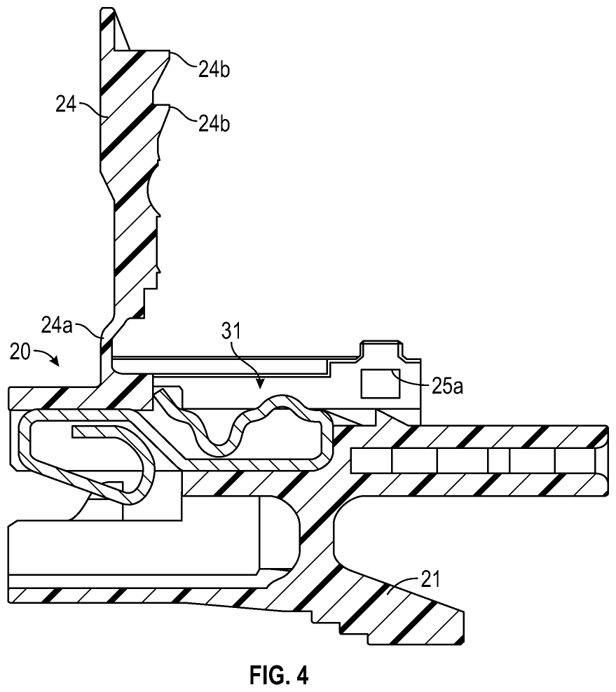

The manner in which the electrical connector assembly 10 is assembled will now be described in detail with reference to FIGS. 4 through 10. FIGS. 4 through 7 show how the first electrically conductive structure 11 is assembled with the housing 20 of the electrical connector assembly 10. Although FIGS. 4 through 10 illustrate the use of the first embodiment 31 of the plurality of spring pin terminals 30 therein, it will be appreciated that either, or both, of the second and third embodiments 32 and 33 of the spring pin terminals 30 may be assembled in the same manner with the housing 20 of the electrical connector assembly 10. Alternatively, the second and third embodiments 32 and 33 of the spring pin terminals 30 may be assembled in different manners with the housing 20 of the electrical connector assembly 10, depending upon the structure, shape, and/or size of the electrical connector assembly 10.

Initially, the locking arm 24 of the body 21 of the housing 20 is moved to the unlocked position shown in FIG. 4. Then, as also shown in FIG. 4, each of the plurality of spring pin terminals 31 is inserted within the interior space 22 of the body 21 so as to be supported therein by the housing 20. More specifically, one of the spring pin terminals 31 is inserted within each of the slots defined within the interior space 22 by the dividers 23 of the body 21 of the housing 20. To facilitate the assembly process, the housing 20 and the spring pin terminals 31 are preferably sized and shaped such that each of the spring pin terminals 31 is resiliently retained within its associated slot within the interior space 22 of the housing 20 when inserted therein, although such is not required.

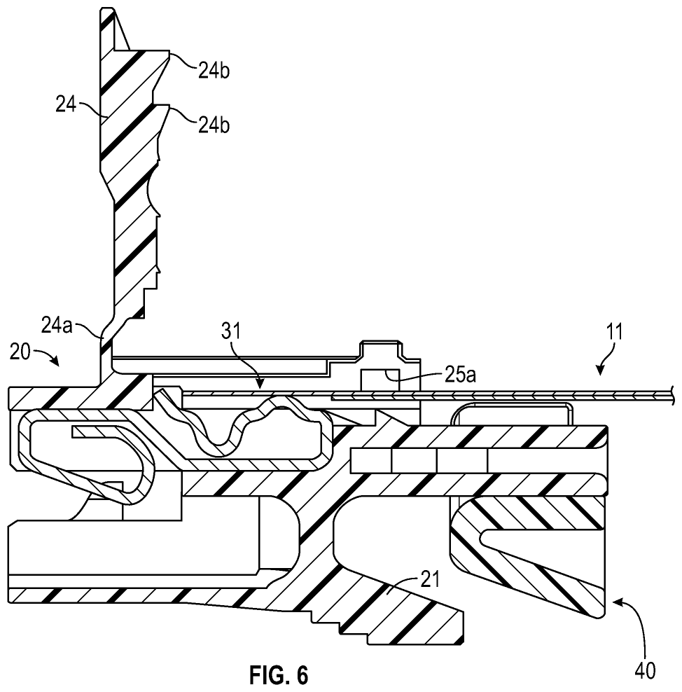

Next, the connector position assurance 40 is aligned with (as shown in FIG. 5) and assembled onto (as shown in FIG. 6) a portion of the body 21 of the housing 20. To accomplish this, the connector position assurance 40 is initially located in an unlocked position relative to the body 21 of the housing 20, as shown in FIG. 5. As also shown in FIG. 5, the first electrically conductive structure 11 is preliminarily positioned relative to the body 21 of the housing 20 such that the traces 11a provided on the first electrically conductive structure 11 are respectively aligned with the spring pin terminals 31 supported within the interior space 22 of the body 21 of the housing 20.

Thereafter, as shown in FIG. 6, the first electrically conductive structure 11 is moved so as to be inserted into engagement with the body 21 of the housing 20. When so moved, the traces 11 a provided on the first electrically conductive structure 11 are respectively disposed adjacent to the first contact portions 31a of the spring pin terminals 31.

FIG. 7 illustrates the final step in the process of assembling the first electrically conductive structure 11 with the housing 20 of the electrical connector assembly 10. As shown therein, the locking arm 24 provided on the body 21 of the housing 20 is moved from the opened position to the closed position. When so moved, the retainer portions 25a and 25b engage one another so as to positively retain the locking arm 24 in the closed position relative to the body 21 of the housing 20, although such is not required. Also, the barbs 24b provided on the locking arm 24 engage respective portions of the first electrically conductive structure 11 to prevent the first electrically conductive structure 11 from being removed from the housing 20 of the electrical connector assembly 10 while the locking arm 24 is in the closed position.

When located in the closed position, the locking arm 24 urges the traces 11a provided on the first electrically conductive structure 11 into engagement with the respective single curved contact points provided on the first contact portions 31a of the spring pin terminals 31. At the same time, the locking arm 24 causes the curved retention force supports provided on the first contact portions 31a of the spring pin terminals 31 to resiliently engage the respective intermediate portions 31c of the spring pin terminals 31. Consequently, the traces 11a provided on the first electrically conductive structure 11 are mechanically and electrically connected to the respective first contact portions 31a of the spring pin terminals 31.

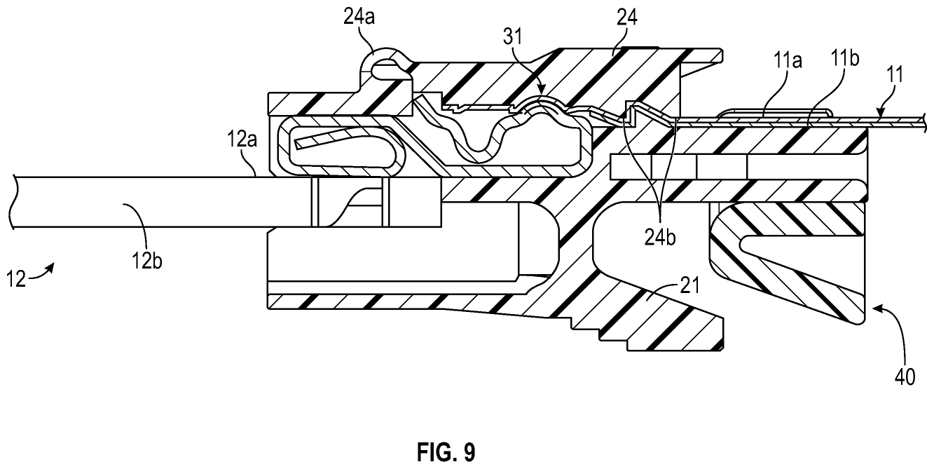

FIGS. 8 through 10 illustrate how the second electrically conductive structure 12 is assembled with the housing 20 of the electrical connector assembly 10. As shown in FIG. 8, the second electrically conductive structure 12 is preliminarily positioned relative to the body 21 of the housing 20 such that the traces 12a provided on the second electrically conductive structure 12 are respectively aligned with the spring pin terminals 31 supported within the interior space 22 of the body 21 of the housing 20. Thereafter, as shown in FIG. 9, the second electrically conductive structure 12 is moved into engagement with the body 21 of the housing 20. When so moved, the traces 12a provided on the second electrically conductive structure 12 are respectively moved into engagement with the linear contact points provided on the second contact portions 31b of the spring pin terminals 31. At the same time, the retention force and alignment supports 31e provided on the second contact portions 31b of the spring pin terminals 31 engage the intermediate portions 31c of the spring pin terminals 31. Consequently, the traces 12a provided on the second electrically conductive structure 12 are positively and electrically connected to the respective second contact portions 31b of the spring pin terminals 31.

If desired, the body 21 of the housing 20 may be structured to facilitate the insertion of the second electrically conductive structure 12 therewith. To accomplish this, the body 21 of the housing 20 may be provided with a cantilevered arm portion having an end (located at reference number 21 in the illustrated embodiment). By applying a force against the end 21 of that cantilevered arm portion toward the body of the housing 20 (i.e., upwardly when viewing FIG. 8), the opposite end of the housing 20 will be flexed in the opposite direction (i.e., downwardly when viewing FIG. 8), thus slightly expanding the opening into which the second electrically conductive structure 12 is inserted. However, the body 21 of the housing 20 may be provided with any other structure for accomplishing this purpose.

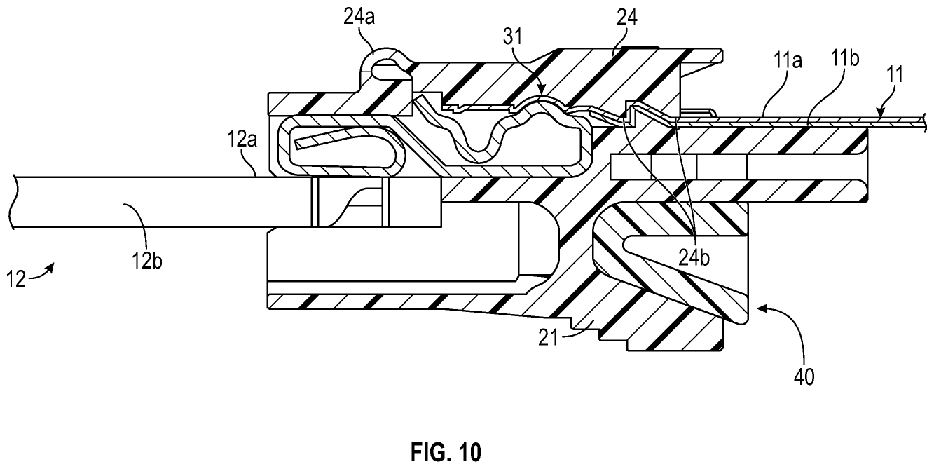

Lastly, as shown in FIG. 10, the connector position assurance 40 is moved from the unlocked position to a locked position relative to the body 21 of the housing 20. As is well known in the art, the connector position assurance 40 provides a mechanism to positively ensure that the components of the electrical connector assembly 10 are properly mated with one another.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A spring pin terminal for use in a housing of an electrical connector assembly that provides mechanical and electrical connections between first and second electrically conductive structures, the spring pin terminal comprising:
a first contact portion;
a second contact portion; and
an intermediate portion that extends between the first contact portion and the second contact portion, wherein:
the first contact portion includes a contact point that is adapted to engage the first electrically conductive structure when inserted within the housing and a retention force support that is adapted to engage the intermediate portion of the spring pin terminal; and
the second contact portion includes a contact point that is adapted to engage the second electrically conductive structure when inserted within the housing and a retention force and alignment support that is adapted to engage the intermediate portion of the spring pin terminal.

2. The spring pin terminal defined in claim 1 wherein the first contact portion includes a single curved contact point that is adapted to engage the first electrically conductive structure and a curved retention force support that is adapted to engage the intermediate portion of the spring pin terminal; and wherein the second contact portion includes a linear contact point that is adapted to engage the second electrically conductive structure and a retention force and alignment support that is adapted to engage the intermediate portion of the spring pin terminal.

3. The spring pin terminal defined in claim 1 wherein the first contact portion includes two curved contact points that are adapted to engage the first electrically conductive structure and a curved retention force support that is adapted to engage the intermediate portion of the spring pin terminal; and wherein the second contact portion includes a linear contact point that is adapted to engage the second electrically conductive structure and a retention force and alignment support that is adapted to engage the intermediate portion of the spring pin terminal.

4. The spring pin terminal defined in claim 1 wherein the first contact portion includes a single curved contact point that is adapted to engage the first electrically conductive structure and a curved retention force support that is adapted to engage the intermediate portion of the spring pin terminal; and wherein the second contact portion includes a curved contact point that is adapted to engage the second electrically conductive structure and a retention force and alignment support that is adapted to engage the intermediate portion of the spring pin terminal.

5. An electrical connector assembly adapted to provide mechanical and electrical connections between first and second electrically conductive structures, the electrical connector assembly comprising:
a housing defining an interior space and a slot; and
a spring pin terminal disposed within the slot of the housing and including:
a first contact portion;
a second contact portion; and
an intermediate portion that extends between the first contact portion and the second contact portion, wherein:
the first contact portion includes a contact point that is adapted to engage the first electrically conductive structure and a retention force support that is adapted to engage the intermediate portion of the spring pin terminal; and
the second contact portion includes a contact point that is adapted to engage the second electrically conductive structure and a retention force and alignment support that is adapted to engage the intermediate portion of the spring pin terminal.

6. The electrical connector assembly defined in claim 5 wherein the first contact portion includes a single curved contact point that is adapted to engage the first electrically conductive structure and a curved retention force support that is adapted to engage the intermediate portion of the spring pin terminal; and wherein the second contact portion includes a linear contact point that is adapted to engage the second electrically conductive structure and a retention force and alignment support that is adapted to engage the intermediate portion of the spring pin terminal.

7. The electrical connector assembly defined in claim 5 wherein the first contact portion includes two curved contact points that are adapted to engage the first electrically conductive structure and a curved retention force support that is adapted to engage the intermediate portion of the spring pin terminal; and wherein the second contact portion includes a linear contact point that is adapted to engage the second electrically conductive structure and a retention force and alignment support that is adapted to engage the intermediate portion of the spring pin terminal.

8. The electrical connector assembly defined in claim 5 wherein the first contact portion includes a single curved contact point that is adapted to engage the first electrically conductive structure and a curved retention force support that is adapted to engage the intermediate portion of the spring pin terminal; and wherein the second contact portion includes a curved contact point that is adapted to engage the second electrically conductive structure and a retention force and alignment support that is adapted to engage the intermediate portion of the spring pin terminal.

9. An assembly comprising:
a first electrically conductive structure;
a second electrically conductive structure; and
an electrical connector assembly including:
a housing defining an interior space and a slot; and
a spring pin terminal disposed within the slot of the housing and including:
a first contact portion;
a second contact portion; and
an intermediate portion that extends between the first contact portion and the second contact portion, wherein:
the first contact portion includes a contact point that engages the first electrically conductive structure and a retention force support that engages the intermediate portion of the spring pin terminal; and the second contact portion includes a contact point that engages the second electrically conductive structure and a retention force and alignment support that engages the intermediate portion of the spring pin terminal.

10. The assembly defined in claim 9 wherein the first contact portion includes a single curved contact point that engages the first electrically conductive structure and a curved retention force support that engages the intermediate portion of the spring pin terminal; and wherein the second contact portion includes a linear contact point that engages the second electrically conductive structure and a retention force and alignment support that engages the intermediate portion of the spring pin terminal.

11. The assembly defined in claim 9 wherein the first contact portion includes two curved contact points that engage the first electrically conductive structure and a curved retention force support that engages the intermediate portion of the spring pin terminal; and wherein the second contact portion includes a linear contact point that engages the second electrically conductive structure and a retention force and alignment support that engages the intermediate portion of the spring pin terminal.

12. The assembly defined in claim 9 wherein the first contact portion includes a single curved contact point that engages the first electrically conductive structure and a curved retention force support that engages the intermediate portion of the spring pin terminal; and wherein the second contact portion includes a curved contact point that engages the second electrically conductive structure and a retention force and alignment support that engages the intermediate portion of the spring pin terminal.
